(19) United States
(12) Patent Application Publication
(10) Pub. No.: US 2009/0174244 A1
(43) Pub. Date: Jul. 9, 2009

(54) Seat height and tilt adjustment apparatus and method

(75) Inventors: Lyle Eugene York, Peoria, IL (US); David Lee Agan, Peoria, IL (US)

Correspondence Address: Caterpillar Inc.;Intellectual Property Dept., AH 9510, 100 N.E. Adams Street, PEORIA, IL, 61629-9510, US

(73) Assignee: Caterpillar Inc.

(21) Appl. No.: 12/006,920

(22) Filed: Jan. 7, 2008

(51) Int. Cl. A47C 1/00; B62D 33/06

(52) U.S. Cl. 297/344.13; 180/89.12

(57) ABSTRACT

A seat height and tilt adjustment apparatus includes first and second arms mounted between two structures. The first arm is pivotally attached to the first structure at the first pivot axis, and pivotally attached to the second structure. The second arm is pivotally attached to the first structure at a second pivot axis and pivotally attached to second structure. A linkage is pivotally attached to the first structure at a third pivot axis and pivotally attached to the first arm. A first actuator adjusts the distance between the two structures by simultaneously varying the distance between the first and second pivot axes and the distance between the first and third pivot axes. A second actuator varies the tilt of one structure relative to the other structure by varying the distance between the first and third pivot axes, while maintaining a constant distance between the first and second pivot axes.

### TECHNICAL FIELD

This disclosure relates generally to seats and, more particularly, to an apparatus and method for adjusting the height and tilt of a seat.

### BACKGROUND

Machines, such as skid steer loaders, multi-terrain loaders, backhoe loaders, agricultural tractors, track-type tractors, articulated trucks, wheel loaders, off-road vehicles, dump trucks, and other types of construction, mining, and agricultural machinery are used for a variety of tasks requiring operator control. Typically, an operator controls these machines while seated in a seat located on the machine. During operation of such machines, it may often be desirable to adjust the height and tilt of the seat to increase the comfort or visibility of the operator.

Various mechanisms have been developed to raise and tilt seats. For example, U.S. patent application Ser. No. 11/246,514 to Le, et al. (“Le”) discloses an apparatus for adjusting the height and tilt of a seat. However, the device disclosed in Le requires that an operator turn two different knobs to adjust the height of a seat without inducing a tilt in the seat.

### SUMMARY OF THE INVENTION

A height and tilt adjustment apparatus adapted for mounting between a first structure and a second structure is provided. A first arm is pivotally connected to the first structure at a first pivot axis and is pivotally connected to the second structure. A second arm is pivotally connected to the first structure at a second pivot axis and is pivotally attached to the second structure. A linkage is pivotally attached to the first structure at a third pivot axis and is pivotally attached to the first arm.

A first actuator is provided to adjust the height of a seat mounted on one of the structures by selectively and simultaneously varying the distance between the first and second pivot axes and the distance between the first and third pivot axes. A second actuator is provided to adjust the tilt of the seat by selectively varying the distance between the first and third pivot axes, while maintaining a constant distance between the first and second pivot axes.

### BRIEF DESCRIPTION OF THE DRAWINGS

FIG. 1 is a perspective view of an apparatus for adjusting the height and tilt of a seat mounted in the cab of a machine.

FIG. 2 is a perspective view of an apparatus for adjusting the height and tilt of a seat.

FIG. 3 is a perspective view of the underside of the apparatus of FIG. 2.

FIG. 4 is a cross sectional view taken along line 4-4 of FIGS. 2 and 3.

FIG. 5 is an enlarged cross sectional view taken along line 4-4 of FIGS. 2 and 3.

FIG. 6 is a diagrammatic view of the apparatus of FIG. 1 in a lowered state.

FIG. 7 is a diagrammatic view of the apparatus of FIG. 1 in a raised state.

FIG. 8 is a diagrammatic view of the apparatus of FIG. 1 in a rearward tilted state.

FIG. 9 is a diagrammatic view of the apparatus of FIG. 1 in a forward tilted state.

### DETAILED DESCRIPTION

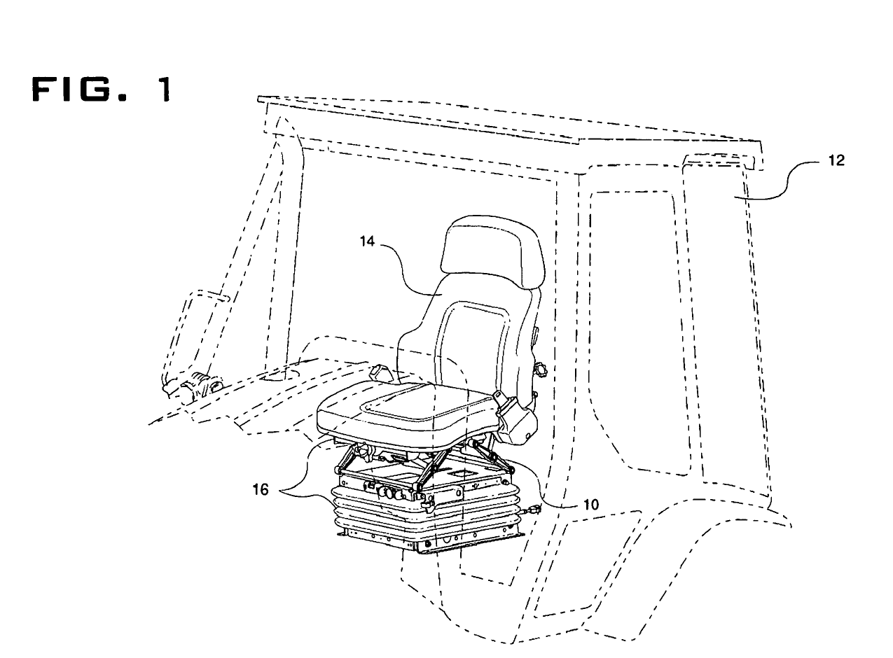

An adjustment apparatus 10 for adjusting the height and tilt of a seat 14 is illustrated in FIG. 1. As illustrated in FIG. 1, adjustment apparatus may be mounted in a cab 12 portion of a machine such that it is interposed, directly or indirectly, between the floor of cab 12 and seat 14.

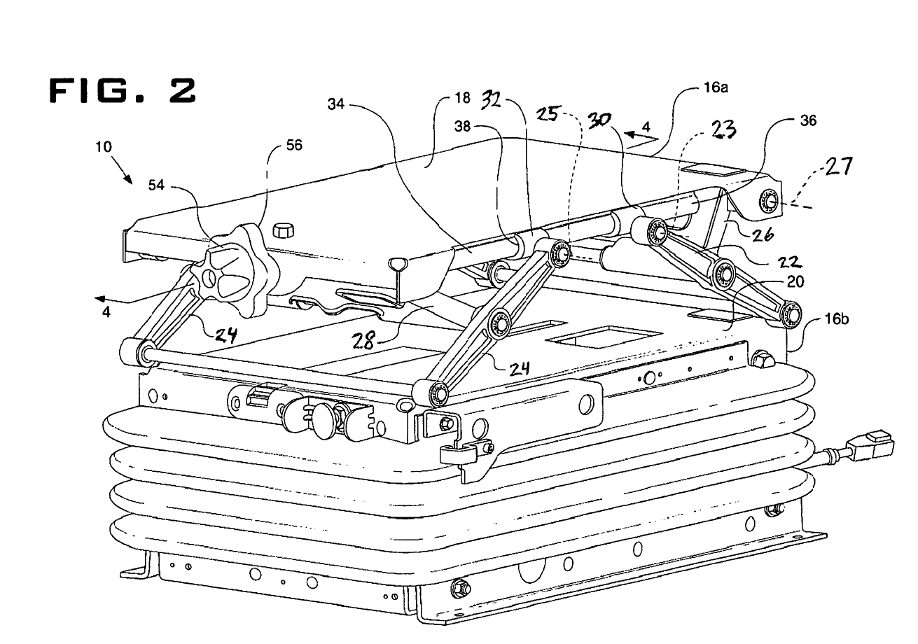

Adjustment apparatus 10 is configured for mounting between two structures 16 and is operable to independently adjust the distance between the structures 16 and the inclination of one structure 16 relative to the other. As illustrated in FIG. 2, a first structure 16a may include a platform 18 for mounting seat 14, and a second structure 16b may include a base 20, which may be, for example, the floor of cab 12, or a structure interposed between such floor and adjustment apparatus 10 for a purpose such as dampening vibration or providing a minimum elevation for seat 14.

Referring to FIG. 2, adjustment apparatus 10 may include a first arm 22 pivotally attached to first structure 16a at a first pivot axis 23 and pivotally attached to second structure 16b. As used herein, first arm 22 may refer to a single arm or a set of arms that move substantially in unison. Similarly, a second arm 24 may be pivotally attached to first structure 16a at a second pivot axis 25 and pivotally attached to second structure 16b. As used herein, second arm 24 may also refer to a single arm or a set of arms that move substantially in unison. Adjustment apparatus 10 may also include a first linkage 26 pivotally attached to first structure 16a at a third pivot axis 27 and pivotally attached to first arm 22. A second linkage 28 may be pivotally attached between first structure 16a and second arm 24.

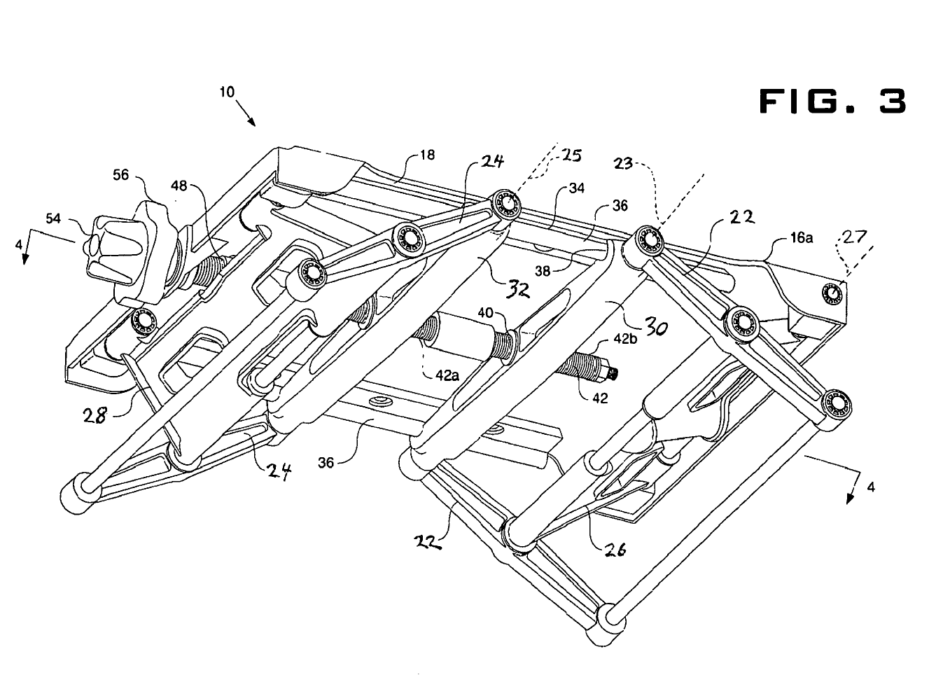

As illustrated in FIGS. 2-4, first and second arms 22, 24 may be pivotally attached to second structure 16b by way of rotary bearings, which may include, for example, roller bearings, ball bearings, sleeve bearings, plain bearings, or any other device known in the art to facilitate rotary motion. First and second arms 22, 24 may also be pivotally attached to a first carriage 30 and a second carriage 32, respectively, which attachment may also be by way of rotary bearings. First and second carriages 30, 32 may, in turn, be slidably engaged with a guide 34 that is configured for attachment to platform 18. Guide 34 may be provided to restrict movement of first and second carriages 30, 32 to a fixed path proximate to platform 18. As best seen in FIG. 3, guide 34 may restrict first and second carriages 30, 32 to linear paths, such as by way of one or more rails 36 attached to platform 18. First and second carriages 30, 32 may be slidably engaged with rails 36 by way of linear bearings 38. Alternate forms of guides may be provided instead of or in addition to rails 36, such as, for example, a tongue disposed in a groove. Additionally, in various embodiments guide 34 may not be necessary, as movement of first and second arms 22, 24 may be sufficiently constrained by other elements of adjustment apparatus 10, such as, by way of example, rotary bearings connecting the various arms and linkages, or an actuator that constrains movement of first and second arms 22, 24.

Each of first and second carriages 30, 32 may include an internally threaded opening 40 in communication with a first threaded shaft 42 having external threads. First threaded shaft 42 may be provided proximate to platform 18 and prevented from movement in the axial direction independent of platform 18. First threaded shaft 42 may restrict movement of first and second carriages 30, 32 with respect to each other. As best seen in FIG. 3, the internally threaded opening 40 of each carriage 30, 32 may communicate with a distinct portion of first threaded shaft 42, a first portion 42a having left-hand threads and a second portion 42b having right-hand threads. The orientation of the threading of first and second portions 42a, 42b may alternatively be reversed. In this manner, when first threaded shaft 42 is turned one direction, first and second carriages 30, 32 move away from each other, and when first threaded shaft 42 is turned the opposite direction, first and second carriages 30, 32 move toward each other.

As shown in FIGS. 2-5, first linkage 26 provides support to adjustment apparatus and restricts non-actuated movement of platform 18 relative to base 20. First linkage 26 may be pivotally attached between platform 18 and first arm 22, such as by way of rotary bearings. In the embodiment depicted in FIGS. 2-5, first linkage 26 is attached to platform 18 at third pivot axis 27. First linkage 26 may be attached to first arm 22 at approximately the midpoint between the attachment of first arm 22 to platform 18 and the attachment of first arm 22 to base 20. Furthermore, the distance between third pivot axis 27 and the attachment of first linkage 26 to first arm 22 may be approximately half the distance between the attachment of first arm 22 to platform 18 and the attachment of first arm 22 to base 20.

As best seen in FIG. 2, second linkage 28 may be dimensioned and attached between platform 18 and second arm 24 in a manner similar to the dimensions and attachment of first linkage 26 between platform 18 and first arm 22. However, second linkage 28 may be slidably attached to platform 18 and/or second arm 24 to allow at least one end of second linkage 28 to slide while platform 18 is being tilted with respect to base 20. The distance second linkage 28 is able to slide may be constrained to limit the amount platform 18 can be actuated to tilt. Alternatively, second linkage 28 may be provided with a variable length. Second linkage 28 may be provided to give additional support and/or rigidity to adjustment apparatus 10; however, second linkage 28 is not required to restrict non-actuated movement of platform 18 relative to base 20.

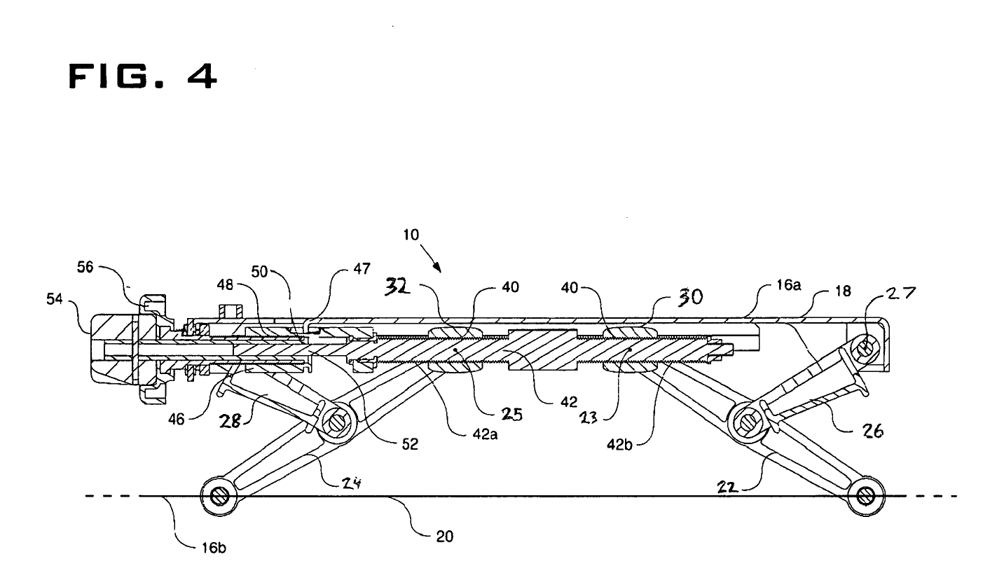

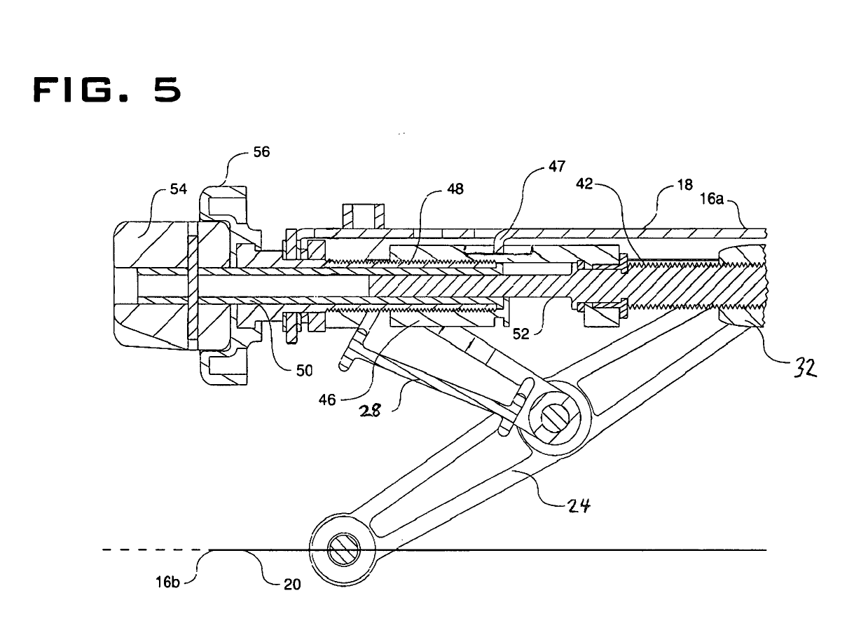

As best seen in FIGS. 4 and 5, first threaded shaft 42 may be coupled with a threaded sleeve 46 having internal threads by way of a rotary bearing. As such, first threaded shaft 42 is free to rotate about its axis independently of threaded sleeve 46, but first threaded shaft 42 is prevented from movement in the axial direction independent of threaded sleeve 46. Threaded sleeve 46 may be prevented from rotating about its axis by a tongue 47 that is fixed with respect to platform 18 and is slidably engaged with a groove in threaded sleeve 46. Threaded sleeve 46 may also be prevented from rotating by other means, such as a tongue fixed with respect to threaded sleeve 46 and slidably engaged with a groove in platform 18.

Threaded sleeve 46 may be threadedly coupled to a second threaded shaft 48 having external threads. Second threaded shaft 48 may be coupled to platform 18 by way of a rotary bearing so as to be prevented from movement in the axial direction independent of platform 18, while being able to rotate about its axis independently of platform 18. As best seen in FIGS. 4 and 5, the external threads of second threaded shaft 48 may be engaged with the internal threads of threaded sleeve 46 such that when second threaded shaft 48 is turned a first direction threaded sleeve 46 and first threaded shaft 42 are pushed away from second threaded shaft 48, and when second threaded shaft 48 is turned a second direction threaded sleeve 46 and first threaded shaft 42 may be pulled toward second threaded shaft 48.

As best seen in FIGS. 4 and 5, second threaded shaft 48 may include a first cavity that is substantially cylindrical and coaxial with second threaded shaft 48, and in which a cylinder 50 may be provided. The outer surface of cylinder 50 may have a circumference substantially corresponding to the circumference of the surface defining the first cavity. In this manner cylinder 50 may be capable of rotation independent of second threaded shaft 48. In turn, cylinder 50 may include a second cavity having a non-circular cross-sectional area, which may be, by way of example, the shape of square, a hexagon, or another non-circular shape.

First threaded shaft 42 may include a non-threaded appendage 52 extending beyond the rotary bearing that couples first threaded shaft 42 to threaded sleeve 46. Non-threaded appendage 52 may be provided in sliding engagement with second cavity and may have a cross-sectional area substantially corresponding to the cross-sectional area of second cavity. In this manner, non-threaded appendage 52 may move in the axial direction independently of cylinder 50 while being substantially rotationally fixed with respect to cylinder 50.

As illustrated in FIGS. 4 and 5, cylinder 50 may be operatively connected to a first knob 54 such that when first knob 54 is turned, cylinder 50 and first threaded shaft 42 are rotated. Similarly, second threaded shaft 48 may be operatively connected to a second knob 56 such that when second knob 56 is turned, second threaded shaft 48 is rotated.

As first threaded shaft 42 is rotated, the external threads of first threaded shaft 42 may interact with the internal threads of internally threaded openings 40 of first and second carriages 30, 32. As discussed above, adjustment apparatus 10 may be configured such that internally threaded openings 40 of first and second carriages 30, 32 are, respectively, in threaded engagement with first and second portions 42a, 42b of the first threaded shaft 42, such that rotation of first threaded shaft 42 causes first and second carriages 30, 32 to move in opposite directions. Thus, when first knob 54 is turned one direction, first and second carriages 30, 32 may move toward each other, and when first knob 54 is turned the other direction first and second carriages 30, 32 may move away from each other.

According to the arrangement of arms 22, 24 and linkages 26, 28 depicted in FIGS. 2-5, as first and second carriages 30, 32 move away from each other, first pivot axis 23 and second pivot axis 25 move away from each other, and first pivot axis 23 moves toward third pivot axis 27. Conversely, as first and second carriages 30, 32 move toward each other, first pivot axis 23 and second pivot axis 25 move toward each other, and first pivot axis 23 moves away from third pivot axis 27.

Also according to the arrangement of arms 22, 24 and linkages 26, 28 depicted in FIGS. 2-5, the distance between third pivot axis 27 and the midpoint between first and second pivot axes 23, 25 remains substantially constant as first and second carriages 30, 32 move toward and away from each other. As such, first pivot axis 23 moves toward/away from third pivot axis 27 at half the rate that first and second pivot axes 23, 25 move away from/toward each other. For example, if first and second pivot axes 23, 25 are actuated to move 30 mm toward each other, first pivot axis 23 will simultaneously move approximately 15 mm away from third pivot axis 27. Thus, in this example, the ratio of the change in the distance between first and second pivot axes 23, 25 to the change in the distance between first and third pivot axes 23, 27 is approximately negative thirty (−30) mm to fifteen (15) mm, or more simply stated approximately negative two to one.

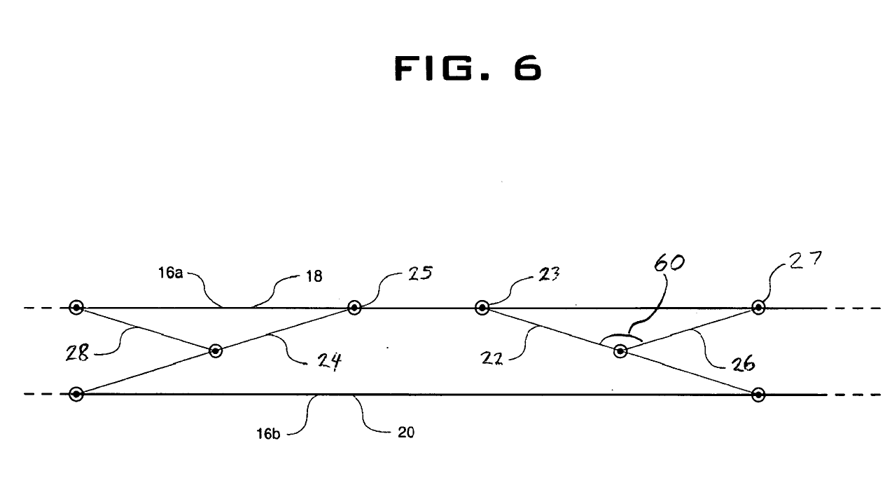

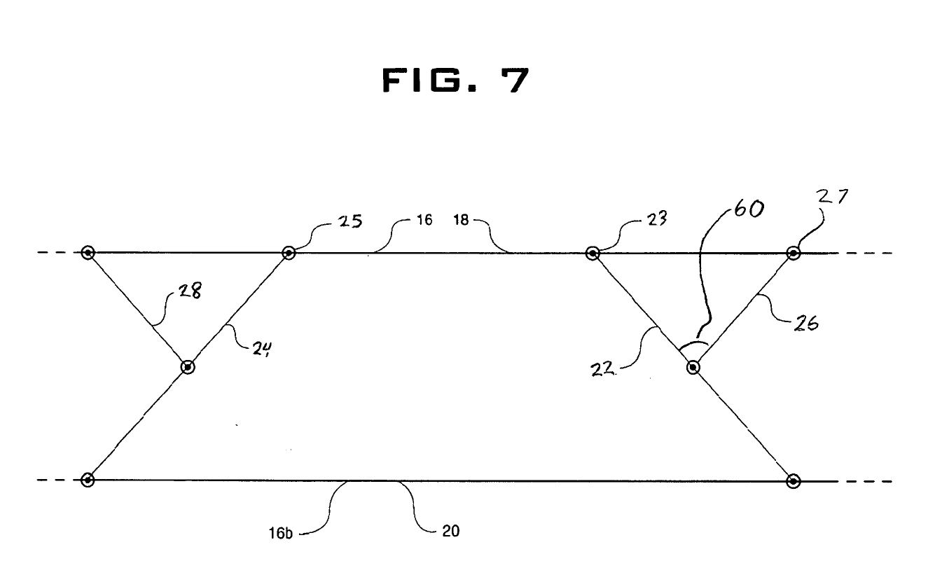

According to the embodiment depicted in FIGS. 2-5, as first and second pivot axes 23, 25 are actuated to move away from each other, first and second arms 22, 24 rotate to an increasingly vertical orientation. As first and second arms 22, 24 become more vertically oriented, the distance between platform 18 and base 20 increases, effectively increasing the height of platform 18 relative to the base 20, thereby increasing the height of seat 14 mounted on platform 18. As the distance between first pivot axis 23 and third pivot axis 27 is simultaneously reduced, the angle 60 between first linkage 26 and first arm 22 is also reduced. Accordingly, first linkage 26 rotates toward an increasingly vertical orientation to facilitate the increase in the height of platform 18 relative to base 20 while continuing to support and constrain platform 18. This operation is depicted diagrammatically in FIGS. 6 and 7, which illustrate the transition from a lowered state of adjustment apparatus 10 to a raised state of adjustment apparatus 10, respectively, without inducing a tilt of platform 18 relative to base 20.

Conversely, as first and second pivot axes 23, 25 are actuated to move toward each other, first and second arms 22, 24 rotate to an increasingly horizontal orientation. As first and second arms 22, 24 become more horizontally oriented, the distance between platform 18 and base 20 decreases, effectively lowering the height of platform 18 relative to base 20, and, thereby, decreasing the height of seat 14 mounted on platform 18. The distance between first pivot axis 23 and third pivot axis 27 is simultaneously increased, resulting in an increase in the angle 60 between first linkage 26 and first arm 22; thus, first linkage 26 rotates toward an increasingly horizontal orientation to facilitate the decrease in the height of platform 18 relative to base 20 while continuing to support and constrain platform 18. FIGS. 7 and 6 diagrammatically illustrate the transition from a raised state of adjustment apparatus 10 to a lowered state of adjustment apparatus 10, respectively, without inducing a tilt of platform 18 relative to base 20.

Also according to the embodiment depicted in FIGS. 2-5, when second knob 56 is turned, it rotates second threaded shaft 48. External threads on second threaded shaft 48 interact with internal threads on threaded sleeve 46 pushing threaded sleeve 46 away from second threaded shaft when second knob 56 is turned one direction, and pulling threaded sleeve 46 toward second threaded shaft 48 when second knob 56 is turned the other direction. As first threaded shaft 42 is coupled to threaded sleeve 46, first threaded shaft 42, together with first and second carriages 30, 32, are pushed and pulled with threaded sleeve 46. As first and second carriages 30, 32 are pulled toward second threaded shaft 48, first and second pivot axes 23, 25 are pulled away from third pivot axis 27. Conversely, as first and second carriages 30, 32 are pushed away from second threaded shaft 48, first and second pivot axes 23, 25 are pushed toward third pivot axis 27.

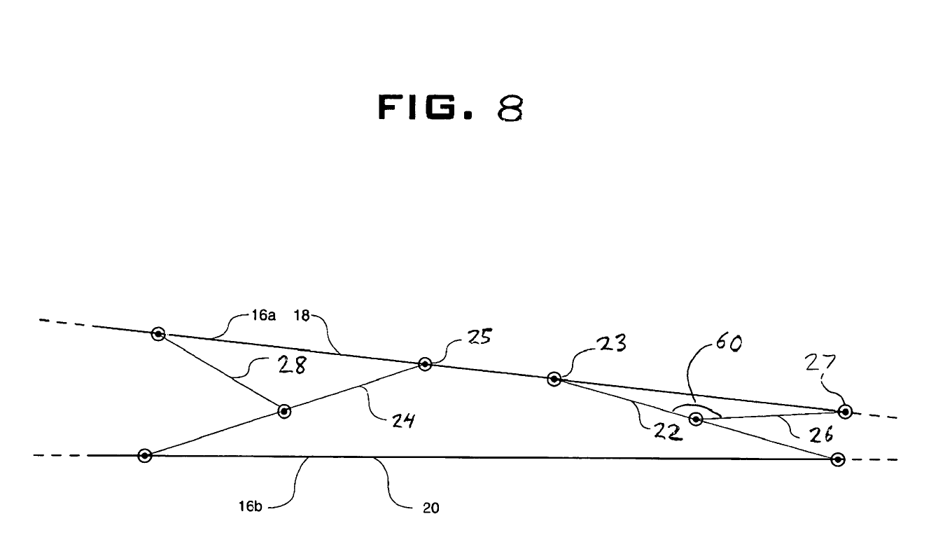

As first and second pivot axes 23, 25 are pulled away from third pivot axis 27, first arm 22 rotates toward an increasingly horizontal orientation and second arm 24 rotates toward an increasingly vertical orientation, increasing height of platform 18 over second arm 24 relative to height of platform 18 over first arm 22. As first pivot axis 23 is pulled away from third pivot axis 27, the angle 60 between first linkage 26 and first arm 22 is increased; thus, first linkage 26 is rotated toward an increasingly horizontal position that facilitates and supports the tilt of platform 18 relative to base 20. This operation is depicted diagrammatically in FIGS. 6 and 8, which illustrate this transition from a non-tilted state of adjustment apparatus 10 to a rearward tilted state of adjustment apparatus 10, respectively.

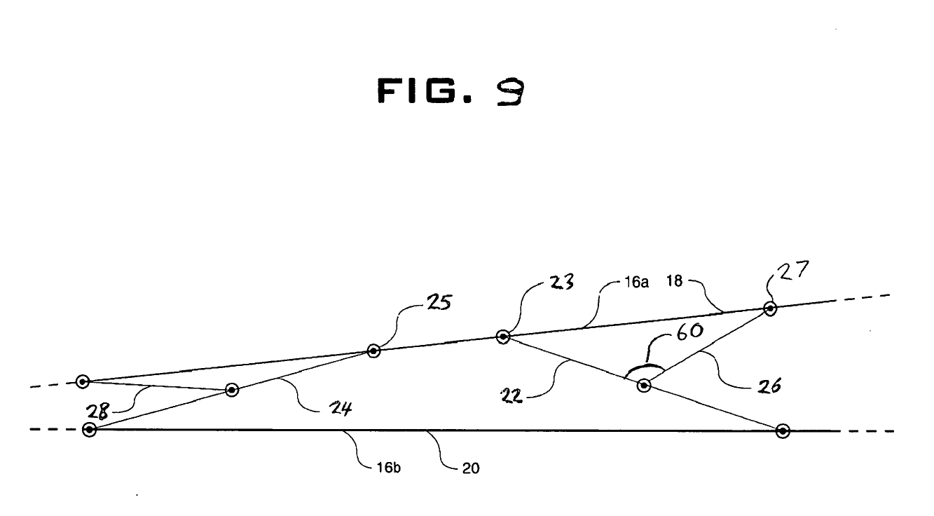

Conversely, as first and second pivot axes 23, 25 are pushed toward third pivot axis 27, first arm 22 rotates toward an increasingly vertical orientation and second arm 24 rotates toward an increasingly horizontal orientation, decreasing height of platform 18 over second arm 24 relative to height of platform 18 over first arm 22. As first pivot axis 23 is pushed toward third pivot axis 27, the angle 60 between first linkage 26 and first arm 22 is decreased; thus, first linkage 26 is rotated toward an increasingly vertical position that facilitates and supports the tilt of platform 18 relative to base 20. FIGS. 6 and 9 diagrammatically illustrate this transition from a non-tilted state of adjustment apparatus 10 to a forward tilted state of adjustment apparatus 10, respectively.

It will be apparent to those skilled in the art that various modifications and variations can be made to the disclosed embodiments without departing from the scope of the invention. For example, vibration dampening may be achieved within adjustment apparatus 10 by providing shock absorbers between various components of adjustment apparatus 10 or integrated into components such as first and second arms 22, 24.

Various configurations of the components of adjustment apparatus 10 are also possible without departing from the scope of the invention. For example, adjustment apparatus 10 could be inverted such that first linkage 26 is attached between base 20 and first arm 22, in which case the mechanisms for adjusting height and tilt, such as first and second threaded shaft 42, 48, threaded sleeve 46, and so forth, would be situated proximate to base 20 rather than proximate to platform 18. Similarly, if adjustment apparatus 10 were inverted, first, second and third pivot axes 23, 25, 27 would be disposed proximate to base 20 rather than proximate to platform 18.

Furthermore, as discussed above, second linkage 28 as illustrated in FIGS. 2-9, provides additional rigidity and support to adjustment apparatus 10; however, second linkage 28 is not essential to the operation of adjustment apparatus 10, and may be omitted if the additional rigidity and support that second linkage 28 may provide are not desired or required.

Additionally, various actuation mechanisms other than those specifically discussed herein could be employed to adjust the height and tilt of the platform 18. For example, electric motors could be employed to turn first and second threaded shafts 42, 48 automatically, instead of knobs 54, 56, which provide a means of manual actuation. In another example, hydraulic cylinders operating in conjunction with a hydraulic pump, could be employed in place of threaded shafts 42, 48 to vary the distances between first pivot axis 23, second pivot axis 25, and third pivot axis 27.

Other embodiments of the invention will be apparent to those skilled in the art from consideration of the specification disclosed herein. It is intended that the specification and examples be considered as exemplary only.

### INDUSTRIAL APPLICABILITY

In operation, adjustment apparatus 10 may be mounted on the floor of a machine, or a structure interposed between the floor and adjustment apparatus 10, in an area provided to house an operator, such as a cab 12. A seat 14 may be mounted on the platform 18 for operator to sit on while operating such machine. In practice, operator may adjust the height of the seat 14 by turning one knob 54, and adjust the tilt of the seat 14 by turning another knob 56. Alternatively, if the adjustment apparatus 10 includes a powered actuator, one such powered actuator may be provided to adjust the height of the seat 14 and another such powered actuator may be provided to adjust the tilt of the seat 14.

What is claimed is:

1. A height and tilt adjustment apparatus configured for mounting between a first structure and a second structure comprising:
a first arm configured for pivotal attachment to the first structure at a first pivot axis and configured for pivotal attachment to the second structure;
a second arm configured for pivotal attachment to the first structure at a second pivot axis and configured for pivotal attachment to the second structure, the first pivot axis and the second pivot axis being a first distance apart;
a first linkage pivotally attached to the first arm and configured for pivotal attachment to the first structure at a third pivot axis, the third pivot axis and the first pivot axis being a second distance apart;
a first actuator disposed to selectively vary the first distance and the second distance; and
a second actuator disposed to selectively vary the second distance while maintaining a substantially constant first distance.

2. The height and tilt adjustment apparatus of claim 1 further comprising a guide disposed to constrain movement of the first pivot axis to a fixed path proximate to first structure.

3. The height and tilt adjustment apparatus of claim 2 wherein the guide constrains movement of the first pivot axis to a substantially linear path.

4. The height and tilt adjustment apparatus of claim 1 wherein the first actuator is adapted to selectively vary the first distance and the second distance such that the ratio of the change in the first distance to the change in the second distance is approximately negative two to one.

5. The height and tilt adjustment apparatus of claim 1, further comprising a second linkage pivotally attached to the second arm and configured for pivotal attachment to the first structure.

6. The height and tilt adjustment apparatus of claim 1, wherein the first linkage is attached to the first arm proximate to the midpoint of the first arm.

7. The height and tilt adjustment apparatus of claim 6, wherein the first arm and the second arm are substantially equal in length and the first linkage is approximately half the length of the first arm.

8. The height and tilt adjustment apparatus of claim 1, wherein the first actuator comprises a first externally threaded shaft having a first portion with right-hand threads and a second portion with left-hand threads.

9. The height and tilt adjustment apparatus of claim 8, wherein the second actuator comprises a second externally threaded shaft and an internally threaded sleeve, wherein the external threads of the second externally threaded shaft are engaged with the internal threads of the internally threaded sleeve, and wherein the first externally threaded shaft is coupled to the internally threaded sleeve by a rotary bearing.

10. The height and tilt adjustment apparatus of claim 3, wherein the guide comprises a rail, and the first arm is pivotally attached to a linear bearing in sliding engagement with the rail.

11. The height and tilt adjustment apparatus of claim 1, wherein a seat is mounted on the first structure.

12. A machine cab comprising:
a first structure;
a second structure;
an adjustment apparatus comprising:
a guide attached to the first structure;
a first carriage in sliding engagement with the guide;
a second carriage in sliding engagement with the guide, the first carriage and the second carriage being a first distance apart;
a first arm pivotally attached to the first carriage and pivotally attached to the second structure;
a second arm pivotally attached to the second carriage and pivotally attached to the second structure;
a first linkage pivotally attached to the first arm and pivotally attached to the first structure, the pivotal attachment of the first linkage to the first arm and the first carriage being a second distance apart;
a first actuator disposed to selectively and simultaneously vary the first distance and the second distance; and
a second actuator disposed to selectively vary the second distance while maintaining a substantially constant first distance.

13. The machine cab of claim 12, wherein the first linkage is attached to the first arm proximate to the midpoint between the pivotal attachment of the first arm to the first carriage and the pivotal attachment of the first arm to the second structure.

14. The machine cab of claim 13, wherein the first arm and the second arm are approximately equal in length, and wherein the first linkage is approximately half the length of the first arm.

15. The machine cab of claim 13, wherein the adjustment apparatus further comprises a second linkage pivotally attached to the first structure and pivotally attached to the second arm proximate to the midpoint between the pivotal attachment of the second arm to the second carriage and the pivotal attachment of the second arm to the second structure.

16. The machine cab of claim 12, wherein the first actuator is disposed to selectively and simultaneously vary the first distance and the second distance such that the ratio of the change in the first distance to the change in the second distance is approximately negative two to one.

17. The machine cab of claim 12, wherein the guide constrains movement of the first carriage to a substantially linear path.

18. A method of varying the height and inclination of a first structure with respect to a second structure comprising the steps:
attaching a guide to the first structure;
slidably coupling a first carriage to the guide;
slidably coupling a second carriage to the guide;
pivotally attaching a first arm to the first carriage and pivotally attaching the first arm to the second structure;
pivotally attaching a second arm to the second carriage and pivotally attaching the second arm to the second structure;
pivotally attaching a first linkage to the first arm and pivotally attaching the first linkage to the first structure at a pivot axis;
increasing the distance between the first structure and second structure by simultaneously moving the first carriage and the second carriage away from each other, and moving the first carriage toward the pivot axis;
decreasing the distance between the first structure and second structure by simultaneously moving the first carriage and the second carriage toward each other, and moving the first carriage away from the pivot axis;
tilting the first structure a first direction with respect to the second structure by simultaneously moving the first carriage and the second carriage toward the pivot axis while maintaining a substantially constant distance between the first carriage and the second carriage; and
tilting the first structure a second direction with respect to the second structure by simultaneously moving the first carriage and the second carriage away from the pivot axis while maintaining a substantially constant distance between the first carriage and the second carriage.

19. The method of claim 18, wherein the guide constrains movement of the first carriage to a substantially linear path.

20. The method of claim 18, wherein, with respect to the step of increasing the distance between the first structure and second structure and the step of decreasing the distance between the first structure and second structure, the movement of the first carriage and the second carriage is such that the ratio of the change in the distance between the first carriage and the second carriage to the change in the distance between the first carriage and the pivot axis is approximately negative two to one.
